(19) United States
(12) Patent Application Publication
(10) Pub. No.: US 2026/0109322 A1
(43) Pub. Date: Apr. 23, 2026

(54) SYSTEMS AND METHODS FOR A SECURE KEYLESS SYSTEM

(71) Applicant: Harman International Industries, Incorporated, Stamford, CT (US)

(72) Inventors: Asadullah ANSARI, Bangalore, Karnataka (IN); Sharath Yadav Doddamane HEMANTHARAJA, Chitradurga, Karnataka (IN)

(21) Appl. No.: 18/575,252

(22) PCT Filed: Jul. 1, 2021
(86) PCT No.: PCT/US2021/040189

§ 371 Date: Dec. 28, 2023

(51) Int. Cl. B60R 25/24; B60R 25/20; H04L 9/08; H04L 9/32

(52) U.S. Cl. CPC B60R 25/241; B60R 25/209; H04L 9/0816; H04L 9/3247; B60R 2325/108

(57) ABSTRACT

Methods and systems are provided for securing vehicle access from cyberattacks via a keyless system. In an embodiment, a method for a vehicular keyless entry system is provided, comprising processing, at a vehicle, a keyless-entry transmission carrying an identification (ID) code portion; decrypting the ID code portion of the keyless-entry transmission using a private key of the vehicle; detecting whether the decrypted ID code portion matches one of a plurality of predetermined function codes of the vehicle; and executing a functionality of the vehicle corresponding with a function code of the vehicle that matches the decrypted ID code portion.

### FIELD

The disclosure relates generally to keyless systems of a vehicle, and more particularly, to securing vehicle access via a keyless system against cyberattacks.

### BACKGROUND

An increase in advanced functionalities of modern day vehicles, such as advanced driver assistance systems, has resulted in an addition of great number of advanced technological components. While the added components enhance existing vehicle functionalities, they may also introduce security vulnerabilities. Keyless entry systems that use radio frequency (RF) signals (e.g., of a fixed frequency) for the transmission and reception of vehicle control functionalities between a driver and a vehicle are among the most sensitive components. Remote keyless entry (RKE) systems and passive keyless entry (PKE) systems are replacing the traditional physical-key methods of opening car doors, as well as providing added functionalities such as starting engines, turning on and off antitheft alarms, and initiating in-cabin thermal control.

Security vulnerabilities associated with autonomous driving modules, wireless communication modules, devices brought into a vehicle, connected infrastructure, and so on may serve as bridge points to access core functionalities of the systems. With the arrival of modern technologies like connected vehicles and Vehicle-to-everything (V2X) communications, vehicles are no longer closed box systems, but rather are multidirectional connected systems. The transmission and reception of the vehicle control functionalities via an RKE system or PKE system may be compromised by cyber attackers through security attacks (such as jamming, spoofing, scan attacks, and so on), which rely on weaknesses within these technologies to remotely control the functioning of vehicle. Hence, more secure cryptography-based RF communication mechanisms may advantageously help thwart cyberattacks and ensure secure vehicle access.

In the current Digital Key Standard, encryption is used for key tracking (e.g., authenticating and/or managing a number of keys and corresponding users and their rights), but encryption is not used in the transmission of commands used to remotely execute functionalities of a vehicle. A common access right to the vehicle may be given to a keyless entry device for a plurality of functionalities, whereby after the keyless entry device is authenticated (e.g., paired), a user (or an intruder) may have access to the plurality of functionalities. Further, individual commands corresponding to the plurality of functionalities may be pre-established by a manufacturer and shared between a plurality of vehicles, where an intruder may learn commands that may be used on the plurality of vehicles. As a result, a command may be compromised and converted into a different command during a cyberattack. For example, a lock command may be converted into an unlock command to gain access to the vehicle.

Security measures outside the Digital Key Standard may be taken. However, the additional security measures may rely on a telematics system of the vehicle, which may differ across vehicles. Additionally, all original equipment manufacturers (OEMs) may not have infrastructure of sufficient complexity to implement the Digital Key Standard.

### SUMMARY

In various embodiments, the technical problems described above may be addressed by a method for a vehicular keyless entry system, comprising processing, at a vehicle, a keyless-entry transmission carrying an identification (ID) code; decrypting the ID code of the keyless-entry transmission using a private key of the vehicle; detecting whether the decrypted ID code matches one of a plurality of predetermined function codes of the vehicle; and executing a functionality of the vehicle corresponding with a function code of the vehicle that matches the decrypted ID code. A plurality of vehicle functionalities-such as opening or closing vehicle doors, opening or closing vehicle windows, engine ignition, and vehicle-alarm control—may correspond respectively with the plurality of function codes, and each individual vehicle functionality may accordingly correspond with its own distinct function code. The keyless entry system may be a remote keyless entry (RKE) system or a passive keyless entry (PKE) system, where a function code may be encrypted by a keyless-entry device, such as a customer identification device (CID), and transmitted via an RF signal to an RF receiver of the vehicle with a digital signature. Authentication and verification of the digital signature may be performed by a controller of an electronic control unit (ECU) of the vehicle, such as a digital cockpit ECU. A successful verification of the digital signature and successful decryption of the function code may trigger the functionality of the keyless entry system based on the function code. Actuation signals may be passed from the ECU (e.g., a digital cockpit ECU) to one or more control ECUs (e.g., body ECU, engine ECU, and so on) through one or more buses, such as a Controller Area Network (CAN) bus, to perform the desired functionalities.

In this way, access rights to the vehicle may be granted for each individual functionality supported, where an authentication step occurs each time a key of the keyless-entry device is selected, rather than a single time at first contact (e.g., pairing). Additionally, each functionality of each vehicle is assigned a unique function code, thereby preventing a learned function code from a first vehicle to be used on in an attack on a second vehicle. For example, a command issued by the keyless-entry device may not be converted into a different command by an intruder to gain access to the vehicle. Thus, adequate security functions may be enforced relating to opening and/or closing vehicle doors and/or windows, igniting or starting an engine, controlling an alarm, and other vehicle functions, thereby preventing an adversary from exploiting weaknesses of a component of the vehicle (e.g., a multimedia radio system), and protecting an integrity of an interior of the vehicle. An additional advantage of the keyless entry systems and methods disclosed herein is that they may not rely on an existing vehicle infrastructure or telematics system, and key provisioning during manufacturing may provide hardware-based security not present in systems that are configurable post-deployment. In various embodiments, technologies compliant with the Digital Key Standard may advantageously be augmented with the mechanisms and methods disclosed herein for a more complete digital key solution.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a schematic block diagram of a secure keyless entry system of a vehicle, in accordance with one or more embodiments of the present disclosure;

FIG. 2A is a schematic block diagram of a system for configuring a keyless entry system, including a vehicle and a customer identification device (CID) paired with the vehicle, in accordance with one or more embodiments of the present disclosure;

FIG. 2B is a schematic block diagram showing a flow of data between the CID and the vehicle of FIG. 2A, in accordance with one or more embodiments of the present disclosure;

FIG. 2C is a schematic block diagram showing a cryptographic message including an ID code portion and a digital signature portion, in accordance with one or more embodiments of the present disclosure;

FIG. 3 is a flowchart illustrating an exemplary procedure for configuring a keyless entry system prior to operation, in accordance with one or more embodiments of the present disclosure;

FIG. 4 is a flowchart illustrating an exemplary procedure for transmitting encrypted data between a CID and a vehicle of a keyless entry system, in accordance with one or more embodiments of the present disclosure; and

FIG. 5 is a flowchart illustrating an exemplary keyless entry procedure for verifying and decrypting a transmission from a CID, in accordance with one or more embodiments of the present disclosure.

### DETAILED DESCRIPTION

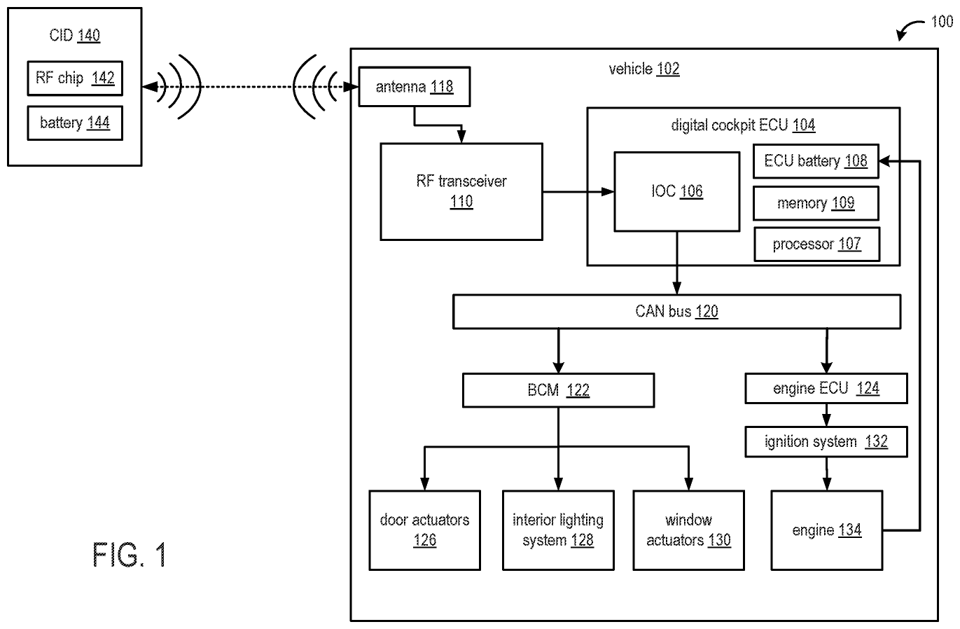

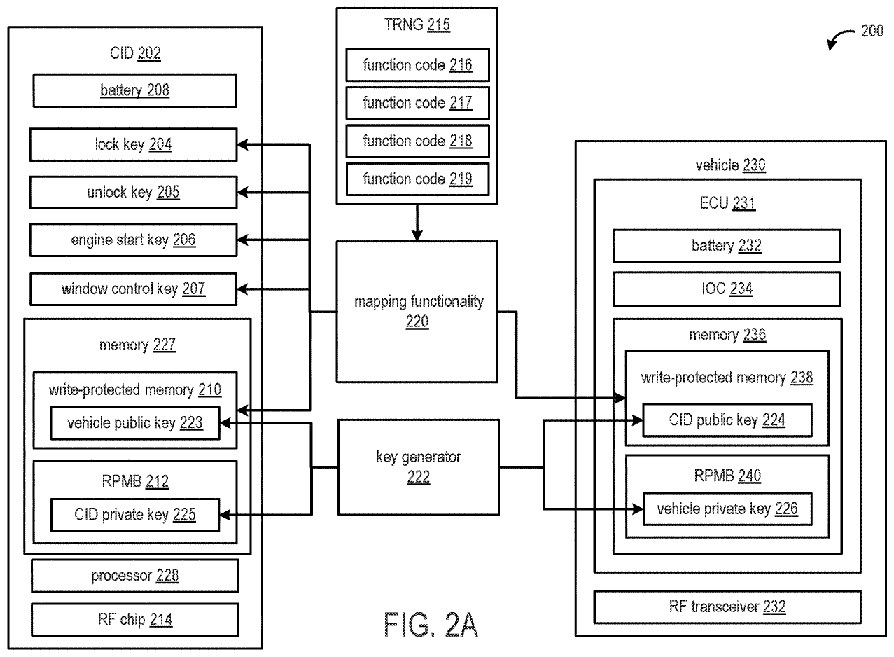

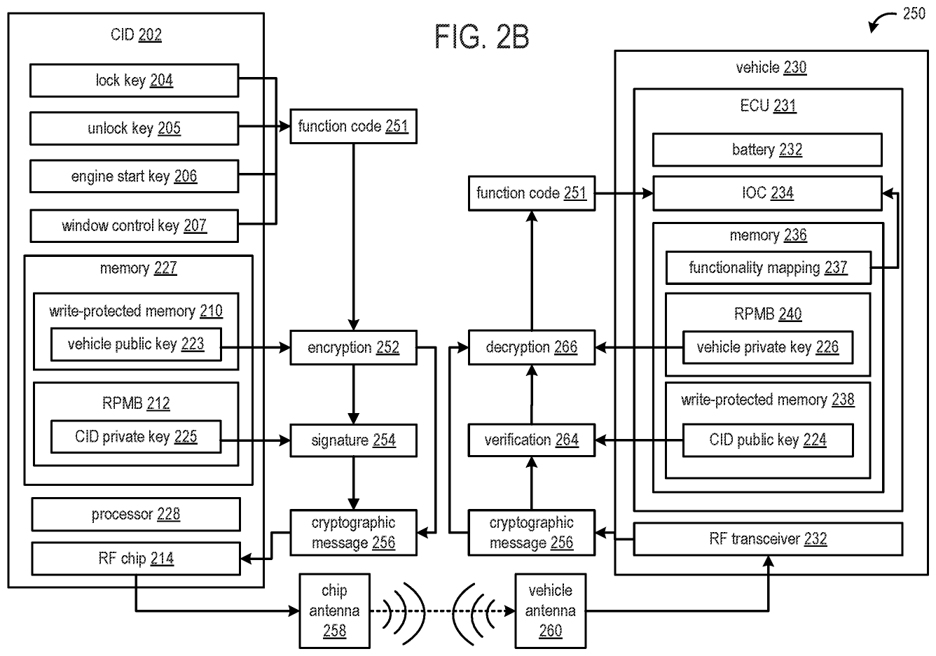

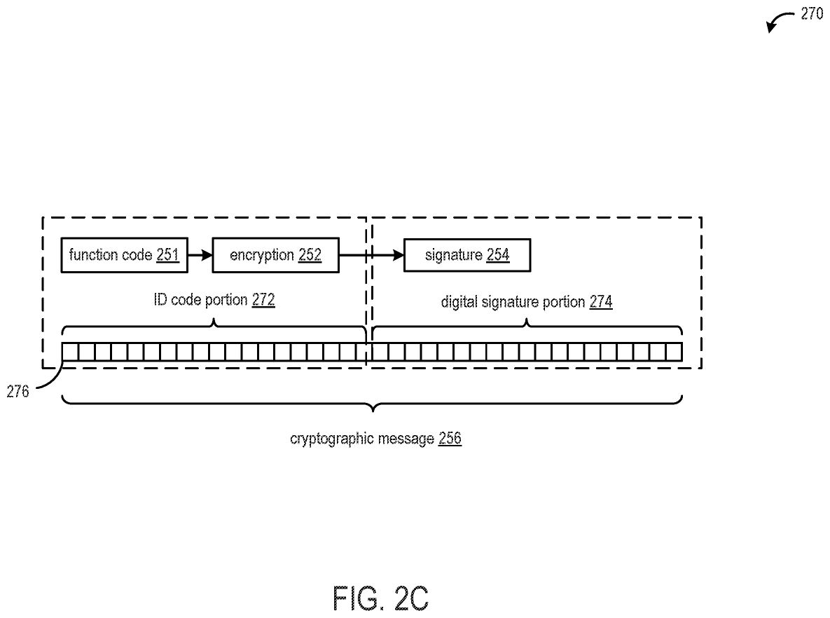

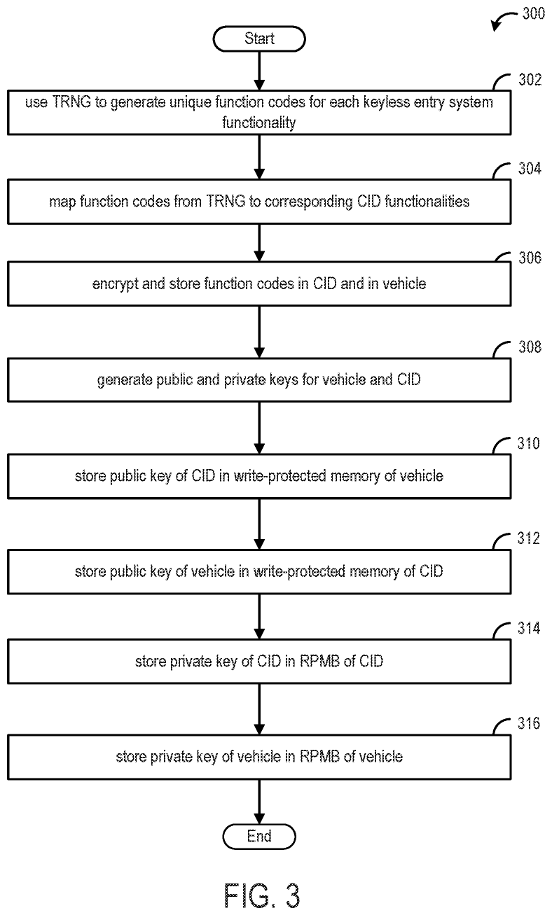

The following detailed description relates to secure keyless entry systems of a vehicle. A vehicle may have a secure keyless entry system, such as the keyless entry system of FIG. 1. A driver of the vehicle may have a keyless entry device of the vehicle (e.g., a key fob), also referred to herein as a customer identification device (CID), which may be configured to be paired with and operate with the vehicle as described in reference to the configuration system of FIG. 2A. A set of function codes that correspond with functionalities of the vehicle and a set of public and private keys may be generated for the CID and the vehicle, in accordance with a procedure such as the method of FIG. 3.

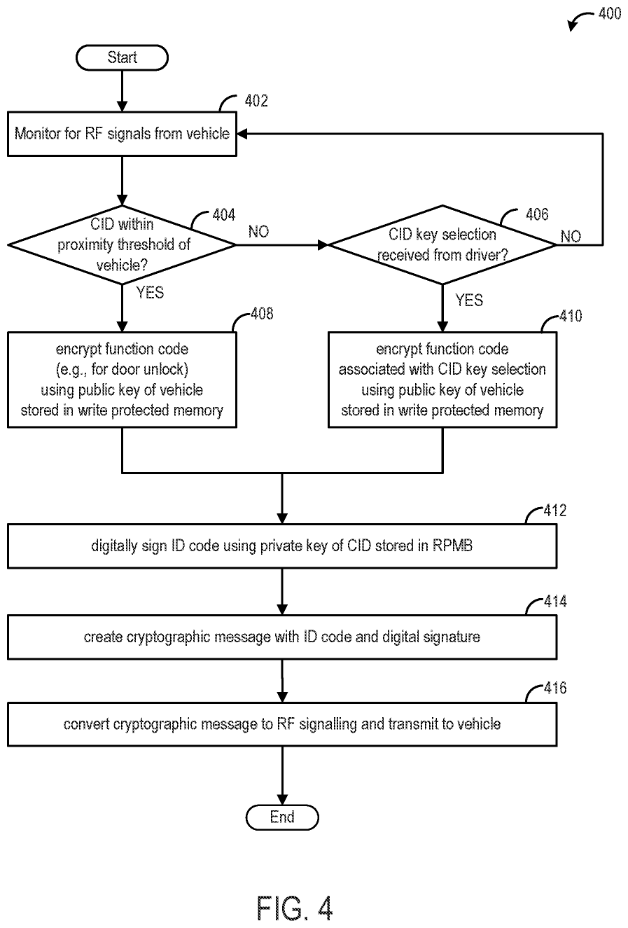

During use of the secure keyless entry system, a key of the CID (e.g., a button on the key fob) may be selected to execute a desired functionality of the vehicle, and information may be transmitted from the CID to the vehicle as shown by the functional diagram of FIG. 2B, via a cryptographic message generated as described in reference to FIG. 2C. The cryptographic message may include an ID code, which may be an encrypted function code corresponding with the desired functionality of the vehicle, and a digital signature of the CID. The CID may transmit a radio frequency (RF) signal with the cryptographic message to the vehicle, via a procedure such as the method of FIG. 4.

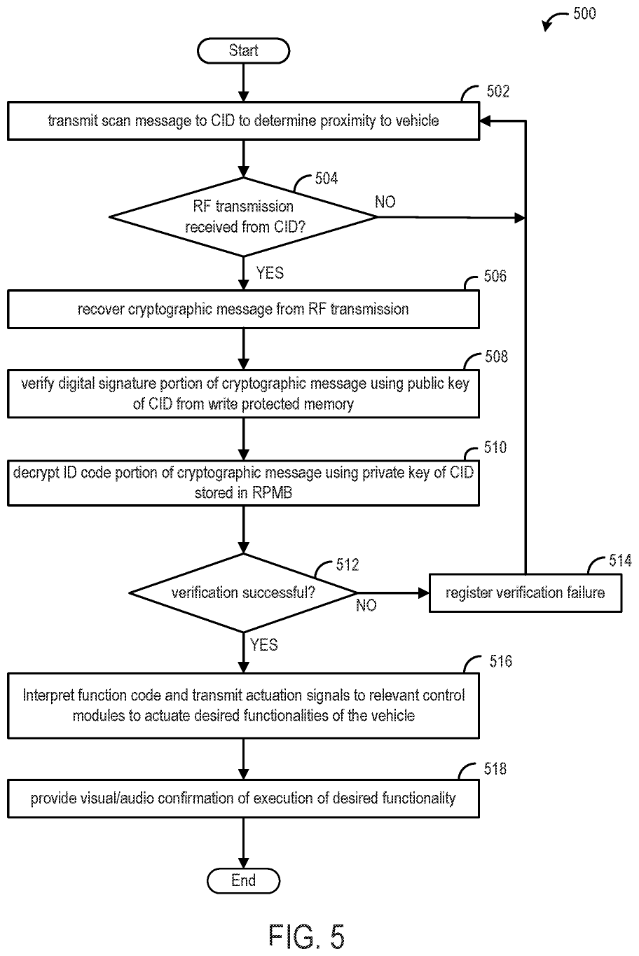

The RF signal may then be received by an electronic control unit (ECU) of the vehicle (such as a digital cockpit ECU), which may process the RF signal and the cryptographic message, via a procedure such as the method of FIG. 5. The digital signature may be verified to authenticate the CID, and the ID code may be decrypted to recover the function code. Based on the function code, the digital cockpit ECU may then perform the desired functionality of the vehicle (e.g., unlocking a door of the vehicle, starting an engine of the vehicle, opening one or more windows of the vehicle, opening a trunk of the vehicle, and so on).

Referring now to FIG. 1, a keyless entry system 100 is shown, including a vehicle 102 in wireless communication with a CID 140, which may be referred to as a keyless entry device. The keyless entry system 100 may be a remote keyless entry (RKE) system, or a passive keyless entry (PKE) system, or a different type of keyless entry system, such as any of the keyless entry systems disclosed herein. The CID 140 may be a handheld device (e.g., a key fob) carried by a driver of the vehicle 102. In some embodiments, the CID 140 may include a mobile application, or any of a variety of types or modes of user interfaces.

The vehicle 102 may include a digital cockpit ECU 104, which may control operations of the keyless entry system 100 via an input output controller (IOC) 106. In some embodiments, the ECU 104 may not be a digital cockpit ECU, and may be a different ECU of the vehicle. The digital cockpit ECU 104 may include a processor 107, which may execute instructions stored in a memory 109 of the digital cockpit ECU 104 to implement portions of the keyless entry system 100. In some embodiments, the digital cockpit ECU 104 may be powered by a power storage device, such as a battery 108. The battery 108 may be a dedicated ECU battery, or the battery 108 may be a specified battery (e.g., for the IOC), whereby power to execute the instructions may be available if power is not available via other power sources of the vehicle. In some embodiments, the battery 108 may be coupled to a belt of the engine 134, and maintained in a charged state during engine operation via a front end accessory drive (FEAD) system of the vehicle 102 (not depicted in FIG. 1). In various embodiments, battery 108 may supply the keyless entry system 100 with sufficient power to operate when the engine 134 is off and/or a main battery of the vehicle 102 is not charged.

In some embodiments, the wireless communication between the vehicle 102 and the CID 140 may be established via an RF link that supports bidirectional communication, whereby RF signals may be transmitted from the CID 140 to the vehicle 102 and/or RF signals may be transmitted from the vehicle 102 to the CID 140. The CID 140 may include an RF chip 142 and a battery 144, which may enable processing of executable instructions for communication and interoperation between the CID 140 and the vehicle 102.

The RF range within which the CID 140 operates may vary between manufacturers. Additionally, an ability of the signal to reach the vehicle 102 may also vary due to blocking of the CID 140 by corner pillars of the vehicle 102 and/or other physical objects that may act to reduce the RF range. In some embodiments, the CID 140 may transmit at a frequency of 315 megahertz (MHz). As components of the CID 140 have been omitted from FIG. 1 for the purpose of simplification, an example configuration of the CID 140 is described in more detail below in reference to FIG. 2A.

The vehicle 102 may include an RF receiver and/or transmitter 110, which may receive a keyless entry transmission (e.g., via RF signals) transmitted from the CID 140 via an antenna 118. (A receiver and/or transmitter may be referred to herein as a transceiver.) The RF signals sent from the RF chip 142 of the CID 140 to the RF transceiver 110 of the vehicle 102 may include encrypted digital data.

When a key (e.g., a button) is pressed on the CID 140, a cryptographic message may be transmitted from the CID 140 to the vehicle 102. The cryptographic message may include an identification (ID) code, which may be based on a function code of the vehicle 102. In various embodiments, the ID code may be an encrypted function code. The cryptographic message may also include various other identifying information of the vehicle 102 and/or the CID 140. The function code upon which the ID code is based may be for actuating or otherwise triggering a functionality of the vehicle 102, such as a remote access function to unlock or lock the vehicle, to open a window of the vehicle, to turn on an engine 134 of the vehicle, to activate a panic signal of the vehicle, to turn a theft detection system of the vehicle on or off, or another function.

In some embodiments, the function code may be specific to the key being pressed. For example, a first key may unlock the vehicle 102, a second key may lock the vehicle 102, a third key may turn on an engine 134, and so on. In another example, a single key may be used to transmit multiple cryptographic messages based on function codes. For example, a lock/unlock key may toggle between transmitting a first cryptographic message based on first function code to lock the vehicle 102, and transmitting a second cryptographic message based on a second function code to unlock the vehicle 102. In still other examples, a combination of keys may be used to transmit a cryptographic message with a single function code. For example, the driver may press a first key to transmit a cryptographic message based on a first function code, may press a second key to transmit a cryptographic message based on a second function code, and may press the first key and the second key at the same time, or in a particular order, to transmit a cryptographic message based on a third function code. It should be appreciated that the examples described herein are for illustrative purposes, and different or additional keys and/or key combinations may be used without departing from the scope of this disclosure.

Although embodiments are described above engaging in wireless communication via RF signaling, other sorts of wireless communication may be employed. For example, the wireless communication between the vehicle 102 and the CID 140 may be established via an infrared (IR) link.

In various embodiments, the keyless entry system is a type of passive keyless (PK) system, where a cryptographic message may be transmitted from the CID 140 to the vehicle 102 without the driver pressing a key. In some embodiments, the PK system may be a PKE system, where a cryptographic message (e.g., including an ID code based on a function code for unlocking and/or locking the vehicle 102) may be transmitted from the CID 140 to the vehicle 102 without the driver pressing a key. For some embodiments, the PK system may be a passive keyless start (PKS) system, where a cryptographic message including an ID code based on a function code for starting the engine may be transmitted from the CID 140 to the vehicle 102 without the driver pressing a key. In some embodiments, the PK system may be a passive keyless entry and start (PKES) system, where both a cryptographic message for unlocking and/or locking the vehicle 102 and/or a cryptographic message for starting the engine may be transmitted from the CID 140 to the vehicle 102 without the driver pressing a key.

PKES systems enable drivers to unlock and start their vehicles by bringing a CID (e.g., a key fob) within a pre-determined threshold distance of the vehicle 102. In various embodiments, a PKES system may use a challenge-response based security protocol between the vehicle 102 and the CID 140, where the vehicle 102 periodically scans for the CID 140 to determine its proximity. If the CID 140 is detected within a threshold distance of the vehicle 102 (e.g., 3 feet), the vehicle 102 sends a challenge (e.g., a digital interrogation) to the CID 140, and an ID of the vehicle 102, and waits for a response from the CID 140. If the vehicle 102 receives an expected response, including a cryptographic message carrying an ID code from the CID 140, the ID code may be decrypted (as discussed further below), and any valid function code thereby recovered may be used to trigger an appropriate remote access function of the vehicle 102 (e.g., unlocking one or more doors, starting the engine, and so on).

Both PK systems and RKE systems may be vulnerable to various types of cyberattacks by an intruder who has the capabilities and skills to build electronic devices to attack security systems. For example, the cyberattack may be a scan attack, where an intruder repeatedly transmits different codes matching the RF transceiver 110 until a matching code is discovered. As another example, the cyberattack may be a playback attack, where an attacker records wireless messages sent to a vehicle, and plays the wireless messages back later when the driver is away. In another example, the cyberattack may be a two-thief attack, where a first thief with a first amplifier pulls a door handle of the vehicle 102 while a second thief with a second amplifier stands next to the driver, and an interrogation message sent to the CID 140 is amplified to appear as if the driver is next to the vehicle 102.

In a further example, the cyberattack may be a challenge forward prediction attack, where in a first step, an intruder records one or more resulting interrogation messages sent from the vehicle 102 when a door handle of the vehicle 102 is pulled. In some examples, the intruder may record the one or more interrogation messages when the driver, or another person pulls the door handle. In a second step, the intruder approaches the vehicle when the driver is away from the vehicle 102, and based on the recorded interrogation messages, sends a predicted subsequent interrogation message. A response from the CID 140 is recorded, which may subsequently be used to open the vehicle 102. In yet another example, the cyberattack may use a jammer or other device that emits signals in the same frequency range as the RF chip 142 to create a strong interference that blocks communication between the CID 140 and RF transceiver 110, whereby when the driver leaves the vehicle 102 and presses the lock key (e.g., button) on the CID, the vehicle 102 will not lock as expected by the driver. Transmitting an ID code from the CID 140 to the vehicle 102 in a cryptographic message, rather than transmitting an unencrypted function code, may advantageously harden or protect the vehicle 102 from cyberattacks such as those discussed above.

After receiving the RF signals with the cryptographic message from the CID 140, the RF transceiver 110 may pass the ID code to the IOC 106, which may ultimately execute an appropriate corresponding remote access function (e.g., door lock/unlock, engine start, and so on). To that end, the IOC 106 may execute instructions (e.g., via cryptographic software) responsible for decrypting the ID code received from the CID 140, as described in detail below in reference to FIG. 5.

In various embodiments, the received cryptographic message may additionally include a digital signature, which may allow for authentication of the CID 140. For example, the IOC 106 may decrypt the ID code and determine whether a valid function code has been recovered (e.g., door lock/unlock, engine start, and so on). The IOC 106 may additionally verify the digital signature to authenticate the CID 140. The IOC 106 may refrain from carrying out the remote access function corresponding with the recovered function code unless the digital signature has also been verified (and the CID 140 thus authenticated). In various embodiments, a portion of the cryptographic message carrying the digital signature may be appended to or concatenated with a portion of the cryptographic message carrying the ID code.

After the ID code has been decrypted by the IOC 106, the resulting decrypted data may be compared to a list of valid function codes of the vehicle 102. If the decrypted data matches any of the valid function codes, the IOC 106 may execute a functionality of the vehicle 102 corresponding with the recovered function code. Executing the desired functionality may include sending one or more control signals to other ECUs of the vehicle 102 to actuate one or more actuators to perform the desired functionality.

The one or more control signals may be sent to the other ECUs via one or more communication buses 120 of the vehicle 102. In various embodiments, the one or more communication buses 120 may include a Controller Area Network (CAN) bus, one or more ECU to ECU communication buses, and/or a different type of bus. The other ECUs may include an engine ECU 124, which may control an ignition of the engine 134 via an ignition system 132. The other ECUs may include a Body Control Module (BCM) 122, which may control a plurality of ECUs and/or actuators relating to various other systems of the vehicle 102. For example, the BCM 122 may control one or more door actuator systems 126 to lock or unlock one or more doors of the vehicle 102. The BCM 122 may control an interior lighting system 128 of the vehicle 102, to turn on or off one or more interior lights of the vehicle 102. The BCM 122 may control one or more window actuator systems 130 of the vehicle 102, to open or close one or more windows of the vehicle 102. It should be appreciated that the examples provided herein are for illustrative purposes, and additional or different ECUs and/or actuators may be controlled (by the BCM 122 and/or other ECUs of the vehicle 102) without departing from the scope of this disclosure.

As an example of the overall operation of the keyless entry system 100, a driver may wish to unlock the vehicle 102 upon approaching the vehicle 102. The driver may press a key on the keyless entry device paired with the vehicle 102 (e.g., the CID 140), which has been assigned a function code that unlocks one or more doors of the vehicle 102. In response to the driver pressing the unlock key, the CID 140 may encrypt the function code to generate an ID code, which may be included in an ID code portion of a cryptographic message. The CID 140 may additionally create a digital signature, which may be included in a digital signature portion of the cryptographic message. The cryptographic message may then be converted to RF signaling, and may be wirelessly transmitted to the vehicle 102 by the RF chip 142 of the CID 140.

At the vehicle 102, the RF transceiver 110 may receive the RF signaling from the RF chip 142 via the antenna 118, and may convert the RF signaling back into the cryptographic message. The RF transceiver 110 may then pass the cryptographic message to the IOC 106 of the digital cockpit ECU 104. The IOC 106 may authenticate the CID 140 by verifying the digital signature of the cryptographic message. Separately, the IOC 106 may decrypt the ID code and may determine whether the resulting data matches a valid function code of the vehicle 102. If a valid function code is recovered by the decryption process, and if the CID 140 has been authenticated as the transmitter of the cryptographic message, the recovered function code (which may have been mapped by software of the IOC 106 to a door unlock function) may generate a signal to the BCM 122 to unlock the one or more doors of the vehicle 102. The signal may be sent to the BCM 122 via the one or more buses 120. When the BCM 122 receives the signal to unlock the one or more doors of the vehicle 102, the BCM 122 may actuate one or more corresponding door actuators 126 of the vehicle 102 to unlock the one or more doors.

As another example of the overall operation of the keyless entry system 100, the vehicle 102 uses a PKE system rather than an RKE system, whereby one or more doors of the vehicle 102 may automatically unlock as the driver approaches the vehicle 102. The IOC 106 may command the RF transceiver to periodically (e.g., once every second) perform a scan for a keyless entry device paired with the vehicle 102 (e.g., the CID 140) within the threshold proximity of the vehicle 102. As the driver enters the threshold proximity upon approaching the vehicle 102, the CID 140 may automatically generate and transmit, for the RF transceiver 110, a cryptographic message with a digital signature portion and an ID code portion to unlock the one or more doors of the vehicle 102. The RF transceiver 110 may pass the cryptographic message to the IOC 106, which may decrypt the ID code and unlock the one or more doors as described above.

As yet another example of the overall operation of the keyless entry system 100, an intruder is positioned within a threshold distance (e.g., 30 feet) of the vehicle 102 as the driver exits the vehicle 102. When the driver exits the vehicle 102, the driver locks one or more doors of the vehicle 102 using the CID 140. Meanwhile, as the driver exits the vehicle 102, the intruder records the RF signal sent from the CID 140 to the vehicle 102, to execute a playback attack. After the driver leaves an area of the vehicle 102, the intruder may replay the recorded RF signal back to the vehicle 102 to attempt to gain access to the vehicle 102. When the intruder replays the recorded RF signal, the recorded RF signal is received by the RF receiver/transmitter 110 via the antenna 118 of the vehicle 102. When the RF receiver/transmitter receives the recorded RF signal, the RF receiver/transmitter may send the cryptographic message to the IOC 106. The IOC 106 may attempt to authenticate the sender of the cryptographic message by verifying the digital signature of the cryptographic message.

In some embodiments, the cryptographic message may not have a digital signature, or may have a digital signature that may not be verified by the IOC 106. As a result of not verifying the digital signature of the cryptographic message, the sender of the recorded RF signal may not be authenticated. In some embodiments, as a result of the sender not being authenticated, the IOC 106 may flag the sender of the cryptographic message as illegitimate and/or might not decrypt the ID code (e.g., as part of rejecting the request). For some embodiments, as a result of the sender not being authenticated, the IOC 106 might not transmit a signal to the BCM 122 to unlock the vehicle 102 via the one or more buses 120, whereby the intruder may be denied access to the vehicle 102. Additionally, the IOC 106 may register a potential cyberattack of the vehicle 102 in one or more log files of the vehicle 102. Thus, by encrypting the relevant ID code, and/or by digitally signing the ID code prior to transmitting the cryptographic message to the vehicle 102, an integrity of an interior of the vehicle 102 may be protected from intruders.

Referring now to FIG. 2A, a block diagram is shown of an example CID configuration system 200 for configuring a keyless entry system (which may be substantially similar to the keyless entry system 100 of FIG. 1). CID configuration system 200 may include a vehicle 230 and a CID 202 paired with the vehicle 230 (which may be substantially similar to the vehicle 102 and the CID 140, respectively, of FIG. 1). In some embodiments, the CID configuration system 200 may be implemented by an original equipment manufacturer (OEM) of the keyless entry system prior to deployment of the vehicle 230.

The CID 202 may include a plurality of keys. For example, the CID 202 may include a lock key 204, an unlock key 205, an engine start key 206, and a window control key 207. In some embodiments, the keys may be buttons arranged on a surface of the CID 202, whereby a key is selected when a corresponding button is pressed. The buttons may be mechanical buttons, capillary sensing buttons, or a different kind of physical button, or the buttons may be virtual buttons arranged on a touchscreen of the CID 202. The buttons may be identified by an icon, text, a color, or a combination of features. In other embodiments, the keys may not be buttons, and a different user interface may be used (e.g., a screen of a mobile device supporting mobile applications). It should be appreciated that the examples provided here are for illustrative purposes and other or different user interface components or combinations of components may be included without departing from the scope of this disclosure.

The CID 202 may include a processor 228, which may execute instructions stored in a memory 227 of the CID 202. The CID 202 may include an RF chip 214, which may be used to wirelessly transmit data of the CID 202 to a corresponding RF transceiver 232 of the vehicle 230, and/or to receive data transmitted to the CID 202 by the RF transceiver 232. For example, upon executing the instructions stored in the memory 227, the processor may cause the RF chip 214 to wirelessly transmit a function code associated with a key of the CID 202 selected by a driver of the vehicle 230 to the vehicle 230 (e.g., to open a door, start an engine of the vehicle 230, and so on). Alternatively, the RF chip 214 may receive a message from the RF transceiver 232, such as a scan message transmitted periodically to determine if the CID 202 is within a threshold proximity of the vehicle 230. The transmitting and receiving of RF signals via the RF chip 214, as well as the processor 228 and the memory 227, may be powered by a battery 208 of the CID 202.

The CID configuration system 200 may include a true random number generator (TRNG) 215, which may generate a number of random function codes for a corresponding number of the keys. For example, if there are 4 keys (e.g., the lock key 204, the unlock key 205, the engine start key 206, and the window control key 207), the TRNG 215 may generate a first random function code 216, a second random function code 217, a third random function code 218, and a fourth random function code 219. In some embodiments, the random function codes for each of the keys are generated by the OEM a single time prior to deployment of the vehicle 230. In some embodiments, the random function codes may be regenerated during a lifetime of the CID 202, for example, if the CID 202 is lost, if a user wishes to change the CID 202, if the OEM wishes to update the random function codes, or for another reason. In still other embodiments, the random function codes for each of the keys may be periodically regenerated, for example, to provide increased security.

The CID configuration system 200 may include a mapping functionality 220. Once the random function codes are generated by the TRNG 215, the mapping functionality 220 may assign the random function codes to a corresponding key. For example, the first random function code 216 may be assigned to the lock key 204, where the first random function code 216 may correspond with a vehicle functionality for locking the vehicle 230; the second random function code 217 may be assigned to the unlock key 205, where the second random function code 217 may correspond with a vehicle functionality for unlocking the vehicle 230; the third random function code 218 may be assigned to the engine start key 206, where the third random function code 218 may correspond with a vehicle functionality for starting the vehicle 230; and the fourth random function code 219 may be assigned to the window control key 207, where the fourth random function code 219 may correspond with a vehicle functionality for opening one or more windows of the vehicle 230.

A mapping of keys of the CID 202 to function codes may then be stored in the CID 202, such as in the memory 227. In some embodiments, the mapping of keys of the CID 202 to function codes may be stored in a write-protected memory block 210 of the memory 227. After deployment, the mapping of keys to function codes may be accessed and processed by the processor 228.

Similarly, a mapping of function codes to functionalities of the vehicle 230 may be stored in a memory of the vehicle 230. In some embodiments, the mapping of function codes to functionalities may be stored in a memory 236 of the ECU 231 (which may be substantially similar to the memory 109 and the digital cockpit ECU 104, respectively). In some embodiments, the mapping of function codes to functionalities of the vehicle 230 may be stored within a write-protected memory block 238 of the memory 236. After deployment, the mapping of function codes to functionalities may be accessed and processed by an IOC 234 of the vehicle 230 (e.g., the IOC 106 of the keyless entry system 100 of FIG. 1), as described in greater detail below in reference to FIG. 2B. Processing of the function code mapping may be powered by a battery 232 of the ECU 231.

The memory 227 of the CID 202 may include instructions which, when executed, cause the CID 202 to encrypt the function codes prior to transmitting them to the vehicle 230. Similarly, the memory 236 of the vehicle 230 may include instructions which, when executed, cause the vehicle 230 to decrypt received function codes from the CID 202.

In various embodiments, the function codes may be encrypted and decrypted using a public-key encryption technique, where public and private key pairs are assigned to the CID 202 and the vehicle 230 by a key generator 222. Accordingly, in various embodiments, the key generator 222 may assign a CID private key 225 to the CID 202 (which may be stored in a secure storage location of the memory 227 of the CID 202, such as a Replay Protected Memory Block (RPMB) 212), and a corresponding CID public key 224 (which may be stored in the write-protected memory 238 of the vehicle 230). Similarly, the key generator 222 may assign a vehicle private key 226 to the vehicle 230 (which may be stored in a secure storage location of the memory 236 of the vehicle 230, such as an RPMB 240), and a corresponding vehicle public key 223 (which may be stored in the write-protected memory 210 of the memory 227 of the CID 202). In some embodiments, the key generator 222 may be operated by a manufacturer of the CID 202 and/or the vehicle 230. Use of the public and private key pairs for encryption and digital signing of the function codes at the CID 202 and for decryption and signature verification at the vehicle 230 are described in greater detail below in reference to FIG. 4 and FIG. 5, respectively.

Turning to FIG. 3, an exemplary method 300 shows a high level procedure for configuring a CID (e.g., the CID 202) and a vehicle (e.g., the vehicle 230) of a keyless entry system (e.g., the keyless entry system 100), prior to deployment of the vehicle. In some embodiments, the method 300 may be executed by a CID configuration system operated by a manufacturer of the keyless entry system (e.g., the CID configuration system 200). As such, one or more parts of the method 300 may be carried out in reference to one or more elements of FIG. 2A.

The method 300 starts at a part 302, where the method 300 includes using a TRNG (e.g., the TRNG 215) to generate a set of unique random function codes, where each random function code of the set of unique random function codes corresponds with a functionality associated with the keyless entry system. Thus, each functionality associated with the keyless entry system may correspond to a key of the CID. For example, the keyless entry system depicted in FIG. 2A offers four functionalities corresponding to four keys: a lock functionality associated with a lock key (e.g., the lock key 204), an unlock functionality associated with an unlock key (e.g., the unlock key 205), an engine start functionality associated with an engine start key (e.g., the engine start key 206), and a window control functionality associated with a window control key (e.g., the window control key 207). For each of the four functionalities, the TRNG may generate a unique random function code, which may be assigned to a corresponding functionality by a separate mapping functionality.

At a part 304, the method 300 includes mapping the generated unique random function codes to corresponding keyless entry system functionalities. In some embodiments, a mapping functionality of the CID configuration system (e.g., the mapping functionality 220) may perform the mapping. For example, the mapping functionality may map the first random function code (for the lock key) to the lock functionality of the vehicle, the second random function code (for the unlock key) to the unlock functionality of the vehicle, the third random function code (for the engine start key) to the engine start functionality of the vehicle, and the fourth random function code (for the window control key) to the window control functionality of the vehicle. In this way, unique random identifiers may be assigned to each key of the four keys, which may be used by the vehicle to identify a key of the four keys that has been selected (e.g., by a driver of the vehicle).

At a part 306, the method 300 includes storing the function codes both in the CID and in the vehicle. In some embodiments, the function codes are stored in a write-protected memory of an ECU of the vehicle (e.g., the write-protected memory 238 of the vehicle 230), where the function codes may be accessed by an IOC of the vehicle (e.g., the IOC 234 of FIG. 2A). Similarly, the function codes may be stored in a write-protected memory of the CID (e.g., the write-protected memory 210 of the CID 202), where a processor of the CID may retrieve a function code when a corresponding key of the CID is selected by the driver. Thereafter, if the driver selects the unlock key of the CID, the processor of the CID may retrieve the function code corresponding to the unlock key of the CID and the unlock functionality of the vehicle; if the driver selects the engine start key of the CID, the processor of the CID may retrieve the function code corresponding to the engine start key of the CID and the engine start functionality of the vehicle; and so on. As described in greater detail below in reference to FIG. 4, the function code retrieved by the processor may be transmitted to the vehicle to trigger the corresponding functionality.

At a part 308, the method 300 includes generating a public key and a private key for both the vehicle and the CID. In some embodiments, a key generator of the CID configuration system (e.g., the key generator 222) generates the public key and the private key in accordance with a selected public key encryption cryptosystem. The public key encryption cryptosystem may be one of a variety of encryption cryptosystems that rely on public/private keys, such as, for example, an Elliptic Curve Cryptography system, an ElGamal cryptosystem, a Rivest-Shamir-Adelman (RSA) Cryptosystem, a Paillier cryptosystem, a Cramer-Shoup cryptosystem, a YAK authenticated key agreement protocol, an NTRUEncrypt cryptosystem, or a McEliece cryptosystem.

In some embodiments, the public key and the private key may be numbers that are generated together as a pair using prime factoring, where the private key and the public key are based on one or more operations performed on combinations of prime numbers. A cryptographic message encrypted with the public key (e.g., of the vehicle) may be decrypted with the corresponding private key (of the vehicle). Additionally and/or alternatively, a cryptographic message may be signed with a digital signature using the private key (e.g., of the CID paired with the vehicle), which may be verified (e.g., authenticated) using the corresponding public key. Without knowing the prime numbers used to generate a public/private key pair, it may be computationally difficult (e.g., time consuming) to decrypt the cryptographic message without knowing the corresponding private key, or to verify the cryptographic message without knowing the corresponding public key. Encryption, decryption, and verification of cryptographic messages using public and private keys is described in greater detail below in reference to FIG. 4 and FIG. 5.

Once the public and private keys have been generated, the public and private keys of the CID and the vehicle are exchanged and stored. At a part 310, the method 300 includes storing the public key of the CID in write-protected memory of the vehicle (e.g., the write-protected memory 238 of the vehicle 230). At a part 312, the method 300 includes storing the public key of the vehicle in write-protected memory of the CID (e.g., the write-protected memory 210 of the CID 202). The public key of the CID and the public key of the vehicle may be publicly available, whereby additional security mechanisms for protecting the public keys of the CID and the vehicle may not be provided. (In various embodiments, the public keys of the CID and the vehicle might not actually be publically disclosed by a manufacturer.)

At a part 314, the method 300 includes storing the private key of the CID in a secure storage area of the CID, such as an RPMB (e.g., the RPMB 212 of the CID 202). The RPMB may include a separate, self-contained security protocol to protect stored data against a replay attack of the sort described above. Thus, by storing the private key of the CID in the RPMB of the CID, the private key of the CID may advantageously be more protected against a replay attack than if it were stored in a write-protected memory of the CID.

At a part 316, the method 300 includes storing the private key of the vehicle in a secure storage area of the vehicle, such as an RPMB (e.g., the RPMB 240 of the vehicle 230). By storing the private key of the vehicle in the RPMB of the vehicle, the private key of the vehicle may advantageously be more protected against a replay attack than if it were stored in a write-protected memory of the vehicle.

Referring now to FIG. 2B, a functional diagram 250 shows an example flow of data between the CID 202 and the vehicle 230 during operation of a keyless entry system (e.g., after configuration of the CID 202 and the vehicle 230 as described above in reference to the CID configuration system 200).

In some embodiments, the keyless entry system may be an RKE system, and the example flow of data is initiated by a driver of the vehicle 230 selecting a key of the CID 202. For example, the driver may select the unlock key 205 of the CID 202 when approaching the vehicle to unlock a door of the vehicle 230, or the driver may select the engine start key 206 to warm up an engine and/or cabin of the vehicle 230 prior to operating the vehicle 230. In other embodiments, the keyless entry system may be a PKE system, and the example flow of data is initiated by the CID 202 entering within a threshold proximity of the vehicle 230 (e.g., to unlock a door of the vehicle 230).

When the driver selects a key of the CID 202 or enters the threshold proximity, a function code 251 associated with the key and/or PKE functionality (e.g., unlocking the door) may be encrypted by the processor 228 of the CID 202 at an encryption code block 252. The encryption code block 252 may output an ID code, where the ID code is the encrypted function code. In some embodiments, the function code 251 may be a random number generated by a TRNG of a manufacturer of the vehicle 230 (such as the TRNG 215). In some embodiments, the encryption code block 252 may encrypt the selected and/or desired function code 251 using a public key encryption cryptosystem, as described above in reference to the method 300 of FIG. 3.

Accordingly, in various embodiments, encryption of the function code 251 may be accomplished using the vehicle public key 223 (e.g., the public key of the vehicle 230), which may be assigned to the vehicle 230 and stored in the write-protected memory 210 of the CID 202 (e.g., by CID configuration system 200, during a configuration stage prior to deployment of the vehicle 230). The vehicle public key 223 may be a publicly available code of the vehicle 230 of a sort used in public key encryption systems. Messages encrypted with the vehicle public key 223 might not be computationally feasible to decrypt without using the corresponding vehicle private key 226.

In various embodiments, the ID code (e.g., the encrypted function code generated by the encryption code block 252) may be inputted into a signature code block 254. At the signature code block 254, the ID code may be digitally signed, whereby a digital signature may be created based upon the CID private key 225 (stored in the RPMB 212 of the CID 202) and the ID code. Digital signatures created with the CID private key might not be computationally feasible to verify without using the corresponding CID public key 224. The digital signature may be created using one of a variety of digital signature algorithms, such as RSA, Digital Signature Algorithm (DSA), Elliptic Curve Digital Signature Algorithm (ECDSA), Edwards-curve Digital Signature Algorithm (EDDSA), RSA with Secure Hash Algorithm (SHA), and so on. The digital signature is described in greater detail below in reference to FIG. 4.

A digital signature outputted by the signature code block 254 may be combined with the ID code to form a cryptographic message 256, where the cryptographic message 256 includes at least an ID code portion and a digital signature portion. In some embodiments, the cryptographic message 256 may be a concatenation of a first string of bits representing the ID code portion, and a second string of bits representing the digital signature portion, as shown in FIG. 2C.

Referring briefly to FIG. 2C, a cryptographic message formation diagram 270 shows an exemplary array of bits 276 representing the cryptographic message 256, where the array of bits 276 is a concatenation of an ID code portion 272 and a digital signature portion 274. The ID code portion 272 may carry an ID code output of the encryption code block 252 as described above, the encryption code block 252 having received the selected and/or desired function code 251 as an input. Similarly, the digital signature portion 274 may carry a digital signature output of the signature code block 254 as described above, the signature code block 254 having received the ID code output of the encryption code block 252.

Returning to FIG. 2B, the cryptographic message 256 may be transmitted to the vehicle 230 via the RF chip 214. In some embodiments, the cryptographic message 256 may be converted into one or more RF signals by the RF chip 214 and transmitted by a chip antenna 258 of the CID 202. The RF signals may be subsequently received by a vehicle antenna 260 of the vehicle 230 and may be converted back into the cryptographic message 256 by the RF transceiver 232. In other embodiments, the cryptographic message 256 may be transmitted using a different kind of wireless digital transmission technique.

As described above in reference to FIG. 2C, the cryptographic message 256 transmitted by the CID 202 may comprise a digital signature portion and an ID code portion. The digital signature of the cryptographic message 256 may be verified by a verification code block 264 of the vehicle 230. In some embodiments, the verification code block 264 may be executed by the IOC 234 of the ECU 231 of the vehicle 230. During verification, the digital signature created at the CID 202 with the CID private key 225 (in the RPMB 212 of the CID 202) is verified in the ECU 231 of the vehicle 230 using the CID public key 224 (in the write-protected memory 238 of the vehicle 230). If the CID public key 224 is successfully used to verify the digital signature of the cryptographic message 256 at the verification code block 264, the CID 202 is thereby authenticated.

The IOC 234 may also pass the cryptographic message 256 to a decryption code block 266 to decrypt the ID code of the cryptographic message. At the decryption code block 266, the vehicle private key 226 (in the RPMB 240 of the vehicle 230) may be used to decrypt the ID code, which was encrypted at the CID 202 using the vehicle public key 223 (in the write-protected memory 210 of the CID 202). After the ID code is decrypted at the decryption code block 266, an output of the decryption code block 266 may be the original function code 251 associated with the selected key of the CID 202 (e.g., the lock key 204, the unlock key 205, the engine start key 206, or the window control key 207, depending on a selection by the driver). The function code 251 may then be processed by the IOC 234. Processing of the function code 251 may include retrieving, from the memory 236, a functionality mapping 237 that maps the function code 251 to a corresponding functionality of the vehicle 230, which may be subsequently be executed.

In some embodiments, verifying the digital signature at the verification code block 264 may include comparing decrypted data of the digital signature (e.g., decrypted using the CID public key 224) with the encrypted ID code included in the ID code portion of the cryptographic message. For example, the decrypted data of the digital signature may be the ID code, where the digital signature is the ID code encrypted with the CID private key 225. If the ID code obtained from the cryptographic message is the same as the ID code obtained by decrypting the digital signature with the CID public key, the CID 202 may be authenticated.

In other, alternative embodiments, verifying the digital signature at the verification code block 264 may include comparing decrypted data of the digital signature with the decrypted function code 251 (e.g., decrypted from the ID code) outputted by the decryption code block 266. For example, in some embodiments, the decrypted data of the digital signature may be the function code 251, where the digital signature is the function code 251 encrypted with the CID private key 225. If the function code 251 obtained by decrypting the ID code of the cryptographic message using the vehicle private key 226 is the same as the function code 251 obtained by decrypting the digital signature with the CID public key, the CID 202 may be authenticated.

In still other embodiments, the decrypted data of the digital signature may be a first hash of the ID code (or the function code 251) (e.g., a value resulting from inputting the ID code or the function code 251 into a hashing function), where the digital signature is the first hash encrypted with the CID private key 225. If a second hash resulting from inputting the ID code (or the function code 251) into the hashing function is the same as the first hash obtained by decrypting the digital signature with the CID public key, the CID 202 may be authenticated. An advantage of using a hash for the digital signature is that a length of the cryptographic message and a corresponding transmission time may be reduced. In some embodiments, the hashing function may be transmitted from the CID 202 to the vehicle 230 in the cryptographic message. In other embodiments, the hashing function may be stored in the memory 227 of the CID 202 and in the memory 236 of the vehicle 230.

In some embodiments, executing the corresponding functionality of the vehicle 230 may include sending an electronic signal to a BCM of the vehicle 230, which may actuate an actuator of the vehicle 230. For example, the function code 251 may correspond to the unlock key 205, whereby the electronic signal may be sent to a BCM (e.g., the BCM 122 of the vehicle 102) responsible for controlling windows and doors of the vehicle 230. The electronic signal may be relayed to one or more door actuators (e.g., the door actuators 126 of the vehicle 102), which may actuate one or more locks of one or more doors of the vehicle to unlock the one or more doors of the vehicle (e.g., the driver's door, or all doors of the vehicle, and so on). Alternatively, the function code 251 may correspond to the lock key 204, whereby the electronic signal sent to the BCM and relayed to the one or more door actuators may actuate the one or more locks to lock the one or more doors of the vehicle.

In another example, executing the corresponding functionality of the vehicle 230 includes sending an electronic signal to an engine ECU (e.g., the engine ECU 124 of the vehicle 102) of the vehicle 230. For example, the function code 251 may correspond to the engine start key 206, indicating that the driver wishes to turn the vehicle 230 on. When the electronic signal is received by the engine ECU, the engine ECU may command an ignition system of the vehicle 230 (e.g., the ignition system 132 of the vehicle 102) to start the engine. It should be appreciated that the examples provided herein are for illustrative purposes and other functionalities of the vehicle 230 may be executed in response to the function code 251 without departing from the scope of this disclosure.

Referring now to FIG. 4, a flowchart is shown illustrating an exemplary method 400 for transmitting a cryptographic message from a CID to a vehicle (e.g., the CID 202 and the vehicle 230, respectively, of FIG. 2A), during operation of a keyless entry system of the vehicle (e.g., the keyless entry system 100 of FIG. 1). The transmitted cryptographic message may include an ID code portion, which may be an encrypted function code, and may include a digital signature portion, which may enable or facilitate authentication of the CID. The function code may be associated with a key of the CID selected by a driver of the vehicle, and the function code may indicate one or more functionalities of the vehicle that may be executed remotely by the driver.

In some embodiments, the keyless entry system is a PK system, where one or more functionalities of the vehicle are executed when the CID is detected within a threshold proximity of the vehicle. For some embodiments, the keyless entry system is an RKE system, where the one or more functionalities of the vehicle are executed in response to an RF signal transmitted by the CID to the vehicle in response to the driver selecting one or more keys of the CID.

The method 400 begins at a part 402, which includes monitoring for an RF signal from the vehicle to determine a proximity of the CID to the vehicle. Following the part 402, the method 400 may proceed to a part 404.

In some embodiments, the proximity of the CID to the vehicle may be determined by measuring a strength of the RF signal transmitted by the vehicle. For example, the CID may be outside a threshold proximity (e.g., 10 feet) of the vehicle, where the strength of the RF signal is below a threshold RF signal strength, or the CID may be within the threshold proximity of the vehicle, where the strength of the RF signal is above the threshold RF signal strength.

In some embodiments, the threshold RF signal strength may be a signal strength at which the RF signal is detected by an RF transceiver of the CID (e.g., the RF chip 214 of FIG. 2A). Thus, when a driver carrying the CID is outside of the threshold proximity, the RF transceiver of the CID does not detect the RF signal, and when the driver enters the threshold proximity, the RF transceiver of the CID detects the RF signal. The signal strength may be determined by measuring an amplitude of the RF signal. In some embodiments, the RF signal is transmitted periodically (e.g., every second) by the vehicle.

In some embodiments, the RF signal received from the vehicle may transmit encrypted or unencrypted data to the CID. In some embodiments, the RF signal includes a challenge message, which the CID uses to authenticate the vehicle. For example, the challenge message may be based on a Rolling Code Technique. In accordance with the Rolling Code Technique, the CID may maintain a first sequence counter, and the vehicle may maintain a second sequence counter. The vehicle may encrypt the first sequence counter based on a shared secret key, and transmit the encrypted first sequence counter to the CID in the challenge message. The CID may subsequently decrypt the encrypted first sequence counter of the challenge message using the shared secret key, and compare it to the second sequence counter. If a difference between the decrypted first sequence counter and the second sequence counter is below a threshold difference, the vehicle may be authenticated.

At the part 404, the method 400 includes determining whether the CID is within the threshold proximity of the vehicle. If at the part 404 it is determined that the CID is within the threshold proximity, the method 400 proceeds to a part 408. Alternatively, if at the part 404 it is determined that the CID is not within the threshold proximity, the method 400 proceeds to a part 406.

At the part 408, the method 400 includes encrypting a predetermined function code of the vehicle (which may be stored in write-protected memory of the CID), as described above in relation to the CID configuration system 200 of FIG. 2A. The predetermined function code may be a function code assigned to a vehicle functionality that has been predetermined to be executed upon detection upon bringing the CID within a threshold distance of the vehicle, and may be encrypted using the public key of the vehicle stored in write-protected memory of the CID. In some embodiments, the predetermined function code is a function code associated with unlocking a door of the vehicle. For some embodiments, the predetermined function code is a function code associated with starting an engine of the vehicle. In some embodiments, a first predetermined function code associated with unlocking the door of the vehicle and a second predetermined function code associated with starting the engine of the vehicle may both be transmitted (e.g., in two respective cryptographic messages). In some embodiments, encrypting the function code into the ID code includes inputting the function code into a hashing function that uses the public key of the vehicle to output the ID code. Following the part 408, the method 400 may proceed to a part 412.

At the part 406, the method 400 includes determining whether a CID key selection has been received from the CID. For example, the driver may select an unlock key of the CID to indicate a desire to unlock the vehicle, or the driver may select a lock key of the CID to indicate a desire to lock the vehicle, or the driver may select a different key of the CID. If at the part 406 it is determined that a CID key selection has been received from the CID, the method 400 proceeds to a part 410. If at the part 406 it is determined that a CID key selection has not been received from the CID, the method 400 returns to the part 402, where the method 400 may continue to monitor for RF signals from the vehicle to determine the proximity to the vehicle.

At the part 410, the method 400 includes encrypting the function code associated with the CID key selection into an ID code. The function code associated with the CID key selection may be encrypted using the public key of the vehicle (which may be stored, e.g., in a write-protected memory of the CID), in accordance with encryption cryptosystems as disclosed herein. For example, the driver may select an unlock key of the CID, and the function code associated with the unlock key may then be encrypted using the public key of the vehicle, or the driver may select a start engine key of the CID, and the function code associated with the start engine key may then be encrypted using the public key of the vehicle. In some embodiments, encrypting the function code into the ID code includes inputting the function code into a hashing function that uses the public key of the vehicle to output the ID code. Following the part 410, the method 400 may proceed to a part 412.

At the part 412, the method 400 includes generating a digital signature by digitally signing the ID code using the private key of the CID (which may be stored, e.g., in an RPMB of the CID), in accordance with digital-signature systems as disclosed herein. To digitally sign the ID code, one of a variety of digital signature algorithms may be used as described above in reference to FIG. 2B, such as RSA, DSA, ECDSA, EDDSA, RSA with SHA, and so on. Following the part 412, the method 400 may proceed to a part 414.

At the part 414, the method 400 includes creating a cryptographic message, where the cryptographic message includes an ID code portion and a digital signature portion. In some embodiments, the cryptographic message may be created by concatenating a first string of bits encoding the ID code and a second string of bits encoding the digital signature, as described above in relation to FIG. 2B. Thus, the encryption and signing of the function code associated with the selected key of the CID may be described in accordance with the following pseudo-code:

ID_Code = Encryption (Function_Code, Public_Key_Vehicle);
Dig_Sig = Signature (ID_Code, Private_Key_CID);
Crypto_Message = [ID_Code + Dig_Sig]

Following the part 414, the method 400 may proceed to a part 416.

At the part 416, the method 400 includes transmitting the cryptographic message wirelessly to the vehicle, using any of a variety of wireless digital transmission techniques that support encoding. In some embodiments, the cryptographic message may be converted to an RF signal for transmission to the vehicle, as described above in relation to FIG. 2B. Method 400 may end following the part 416, and the ending of one iteration of method 400 may lead to the beginning of another iteration of method 400.

In various embodiments, the method 400 may be executed by one or more processors of the CID (such as the processor 228), based on instructions stored in a memory of the CID (e.g., the memory 227). As such, one or more parts of the method 400 may be carried out in reference to one or more elements of FIG. 2B.

Referring now to FIG. 5, a flowchart is shown illustrating an exemplary method 500 for receiving a cryptographic message transmitted by a CID to a vehicle (e.g., the CID 202 and the vehicle 230, respectively, of FIG. 2A), during operation of a keyless entry system of the vehicle (e.g., the keyless entry system 100 of FIG. 1). The received cryptographic message may include an ID code portion, which may be an encrypted function code, and may include a digital signature portion, which may enable or facilitate for authentication of the CID. The function code may be associated with a key of the CID selected by a driver of the vehicle, where the function code indicates one or more functionalities of the vehicle that may be executed remotely by a driver of the vehicle.

In some embodiments, the keyless entry system is a PK system, where the function code corresponds to a key of the CID selected by the driver. For some embodiments, the keyless entry system is an RKE system, where the function code corresponds to a predetermined functionality of the vehicle, such as an unlock functionality.

The method 500 begins at a part 502, which includes transmitting a scan message to the CID to determine a proximity of the CID to the vehicle, as described above in reference to the method 400 of FIG. 4. In some embodiments, the RF signal transmitted by the vehicle includes a challenge message used to authenticate the vehicle, such as a challenge message based on a Rolling Code Technique as described above. Following the part 502, the method 500 may proceed to a part 504.

At the part 504, the method 500 includes determining whether an RF transmission is received from the CID. If at the part 504 it is determined that no RF transmission has been received from the CID, the method 500 proceeds back to the part 502, where the method 500 includes continuing to transmit the scan message to the CID. Alternatively, if at the part 504 is determined that an RF transmission has been received from the CID, the method 500 proceeds to a part 506.

In some embodiments, the keyless entry system is a PK system, and the RF transmission is received in response to the scan message transmitted to the CID by the vehicle, as a result of the CID being within a threshold proximity of the vehicle as described above in reference to the method 400 of FIG. 4. In some embodiments, the keyless entry system is an RKE system, and the RF transmission is initiated by the driver by selecting a key of the CID (e.g., an unlock key, a start engine key, and so on).

At the part 506, the method 500 includes recovering a cryptographic message from the RF transmission. As described above, the cryptographic message may include an ID code portion, and a digital signature portion. Following the part 506, the method 500 may proceed to a part 508.

At the part 508, the method 500 includes verifying a digital signature extracted from the digital signature portion of the cryptographic message using a public key of the CID paired with the vehicle (which may be stored, e.g., in a write protected memory of the vehicle), in accordance with digital signature algorithms as disclosed herein. Following the part 508, the method 500 may proceed to a part 510.

At the part 510, the method 500 includes decrypting the ID code portion of the recovered cryptographic message based upon a private key of the CID paired with the vehicle (which may be stored, e.g., in an RPMB of the vehicle), in accordance with one or more decryption algorithms as disclosed herein. Following the part 510, the method 500 may proceed to a part 512.

At the part 512, the method 500 includes determining whether or not verification of the digital signature is successful. If at the part 512 it is determined that verification of the digital signature was not successful, the method 500 may proceed to a part 514. Alternatively, if it is determined at the part 512 that the verification was successful, the method 500 may proceed to a part 516.

In some embodiments, determining whether or not verification of the digital signature is successful may include comparing a result of decrypting the digital signature portion of the cryptographic message with the ID code portion of the cryptographic message. For example, in some embodiments, the result of decrypting the digital signature may be a first ID code (e.g., where the digital signature was the ID code encrypted with the CID private key), and the decrypted ID code portion of the cryptographic message may be a second ID code. If the first ID code is equal to the second ID code, the digital signature may be verified.

Determining whether or not verification of the digital signature is successful may also include determining whether the decrypted ID code extracted from the recovered cryptographic message matches a valid function code of the vehicle. If the decrypted ID code matches a valid function code of the vehicle, the digital signature may be verified. If the decrypted ID code does not match a valid function code of the vehicle, the digital signature may not be verified. Thus, verifying of the function code associated with the selected key of the CID may be described in accordance with the following pseudo-code:

```
Crypto_Message = [ID_Code + Dig_Sig (ID_Code)]
Verified_ID_Code = Signature_Verification (Dig_Sig(ID_Code),
Public_Key_CID);
If(Verified_ID_Code =ID_Code):
  Function_Code = Decryption (ID_Code, Private_Key_Vehicle);
  If (Function_Code matches valid Function_Code) Trigger vehicle
  functionality
```

In other embodiments, the result of decrypting the digital signature may be a first function code (e.g., where the digital signature was the function code encrypted with the CID private key), and the decrypted function code portion of the cryptographic message may be a second function code. If the first function code is equal to the second function code, the digital signature may be verified. Thus, verifying of the function code associated with the selected key of the CID may be described in accordance with the following pseudo-code:

```
Crypto_Message = [ID_Code + Dig_Sig (Function_Code)]
Verified_Function_Code = Signature_Verification
(Dig_Sig(Function_Code), Public_Key_CID);
Function_Code = Decryption (ID_Code, Private_Key_Vehicle);
If(Function_Code= Verified_Function_Code)
  If (Function_Code matches valid Function_Code) Trigger vehicle
  functionality
```

For some embodiments, a digital signature might not be based upon encrypted data, and the digital signature might instead be based upon a function code rather than a digitally signed ID code as described herein. For such embodiments, decryption of the ID code may be carried out prior to verification of the digital signature. In other words, while FIG. 5 depicts verification of the digital signature (e.g., at part 508) as occurring prior to decrypting the ID code (e.g., at part 510), for embodiments in which the digital signature is based upon directly upon a function code, decryption of the ID code may be executed at part 508 and verification of the digital signature may be executed at part 510.

Furthermore, for some embodiments, a digital signature might not be based upon encrypted data, and the digital signature may be encrypted (either separately from the function code, or together with the function code) such that after the cryptographic message is received, the encrypted digital signature may be decrypted in a first step, and the unencrypted digital signature may be verified in a second step. For example, the function code may be signed at the CID, with the signed function code being subsequently encrypted for transmission to the vehicle via the cryptographic message. At the vehicle, the signed function code may first be decrypted and then verified, as described by the following pseudo-code:

```
Crypto_Message = Encryption (Dig_Sig (Function_Code),
Public_Key_Vehicle)
Digital signature = Decryption (Dig_Sig (Function_Code),
Private_Key_Vehicle);
Verified_Function_Code = Signature_Verification
(Dig_Sig(Function_Code), Public_Key_CID);
If(Function_Code= Verified_Function_Code)
  If (Function_Code matches valid Function_Code) Trigger vehicle
  functionality
```

An advantage of encrypting the signed function code is that it may be more secure against attacks than signing an encrypted function code. In this scenario, the cryptographic message may comprise the encrypted, signed function code without an additional encrypted function code.

In still other embodiments, the result of decrypting the digital signature may be a hash of either the ID code or the function code (e.g., where the digital signature was a hash of the ID code or the function code using a hashing function and encrypted with the CID private key), and the decrypted ID code portion of the cryptographic message may be the second ID code or second function code. If the hash is equal to a result of applying the hashing function to the second ID code or second function code, the digital signature may be verified.

In yet other embodiments, the digital signature may not be a hash of the ID code or the function code, and the digital signature may be a hash of other data of the CID. For example, a different identifier (ID) of the CID may be digitally signed and used for authentication of the CID, where during verification the different ID may be compared with a valid copy of the different ID stored at the vehicle. By not including the ID code or the function code in the digital signature, the function code may only be accessible by decrypting the ID code, which may provide greater security. Additionally, the processes of encrypting/decrypting the function code and generating/verifying the digital signature may be carried out independently, where the digital signature may be generated before encrypting the function code, or the digital signature may be generated after encrypting the function code. It should be appreciated that the examples provided herein are for illustrative purposes, and a different method of verifying the digital signature based on a different encryption and/or signature algorithm may be used without departing from the scope of this disclosure.

At the part 514, the method 500 includes registering a verification failure. Registering the verification failure may include recording a time and/or duration of an intrusion, degree of success of the intrusion, information such as an ID transmitted for verification during the intrusion, signature information of the intruder, and/or other relevant data. A registration of the verification failure may be stored in a memory of the vehicle (e.g., the memory 236 of FIGS. 2A and 2B) and/or transmitted to a cloud-based server for further processing and/or analysis (e.g., by the OEM or vehicle manufacturer). Along with registering the verification failure, the method 500 may proceed back to the part 502, where the method 500 includes continuing to transmit the scan message to the CID.

At the part 516, the method 500 includes interpreting the function code extracted from the recovered cryptographic message (e.g., the decrypted ID code), and if the decrypted ID code matches a valid function code of the vehicle, the method 500 includes transmitting actuation signals to relevant control modules to actuate one or more desired functionalities of the vehicle. The actuation signals may be transmitted from the digital cockpit ECU to a BCM of the vehicle (e.g., the BCM 122 of FIG. 1) via a bus of the vehicle (e.g., a CAN bus), where signals may be used to transmit actuation signals to various actuators of the BCM such as door actuators, window actuators, and so on. The actuation signals may also be transmitted from the digital cockpit ECU to an engine ECU via the signals, for example, to initiate a remote start of an engine of the vehicle. Following the part 516, the method 500 may proceed to a part 518.

At the part 518, the method 500 includes providing a visual and/or audio confirmation of execution of the desired functionalities of the vehicle. Providing visual and/or audio confirmation may include, for example, playing a tone (e.g., a beep) and/or flashing one or more lights (e.g., parking lights) of the vehicle. Method 500 may end following part 518, and the ending of one iteration of method 500 may lead to the beginning of another iteration of method 500.

In various embodiments, the method 500 may be executed by one or more processors of an ECU of the vehicle (such as one or more processors of the ECU 231), which may be a digital cockpit ECU of the vehicle, based on instructions stored in a memory of the vehicle (e.g., the memory 236). As such, one or more parts of the method 500 may be carried out in reference to one or more elements of FIG. 2B.

Thus, when a driver of a vehicle selects a key of a CID to remotely trigger a desired functionality of a vehicle, a secure cryptographic message may be transmitted from the CID to the vehicle. The secure cryptographic message may have an ID code portion and a digital signature portion. The ID code portion may include an encrypted function code, where the function code corresponds with the selected key of the CID corresponding with the desired functionality of the vehicle. The digital signature portion may include a digital signature based on the function code.

The secure cryptographic message may be received by an ECU of the vehicle, the ECU including a dedicated power source, dedicated memory, and an RF transceiver. An IOC of the ECU may extract and decrypt an ID code from the ID code portion of the cryptographic message to receive the function code. The ECU may extract the digital signature from the digital signature portion of the cryptographic message, and verify the digital signature to authenticate the CID.

Verification of the digital signature may include determining whether the function code appears on a list of valid function codes stored in a memory of the ECU. Verification of the digital signature may also include comparing the ID code with a decrypted data of the digital signature (e.g., a second ID code). If the ID code matches the decrypted data, or if the decrypted data matches a result of applying a hashing function to the ID code, the digital signature may be verified and the CID may be authenticated. If the ID code does not match the decrypted data, or if the decrypted data does not match the result of applying the hashing function to the ID code, the digital signature may not be verified and the CID may not be authenticated. By encrypting and decrypting the function codes used to trigger the desired functionality of the vehicle, security functions may be enforced relating to opening and/or closing vehicle doors and/or windows, igniting or starting an engine, controlling an alarm, and other vehicle functions, thereby preventing an adversary from carrying out a cyberattack on the vehicle.

The technical effect of the systems and methods disclosed herein is that by encrypting and digitally signing a function code at a CID prior to transmitting the function code to a vehicle via a cryptographic message, and decrypting and verifying the cryptographic message at the vehicle, cyberattacks on the vehicle may be averted.

The disclosure also provides support for a method for a vehicular keyless entry system, comprising: processing, at a vehicle, a keyless-entry transmission carrying an identification (ID) code portion, decrypting the ID code portion of the keyless-entry transmission using a private key of the vehicle, detecting whether the decrypted ID code portion matches one of a plurality of predetermined function codes of the vehicle, and executing a functionality of the vehicle corresponding with a function code of the vehicle that matches the decrypted ID code portion. In a first example of the method, the private key of the vehicle is stored in a Replay Protected Memory Block (RPMB) of the vehicle. In a second example of the method, optionally including the first example, the decrypting of the ID code portion is done at an electronic control unit (ECU) of the vehicle powered by a secondary power source of the vehicle. In a third example of the method, optionally including one or both of the first and second examples comprising: receiving the keyless-entry transmission via a radio frequency (RF) transceiver coupled to the ECU. In a fourth example of the method, optionally including one or more or each of the first through third examples, the keyless-entry transmission carries a digital signature portion, comprising: verifying the digital signature portion of the keyless-entry transmission based on the ID code portion and a predetermined public key of a keyless-entry device of the vehicle. In a fifth example of the method, optionally including one or more or each of the first through fourth examples, the public key of the keyless-entry device is stored in a write-protected memory of the vehicle. In a sixth example of the method, optionally including one or more or each of the first through fifth examples, the plurality of predetermined function codes corresponding with a plurality of functionalities of the vehicle are generated by a true random number generator (TRNG) for the vehicle and are assigned to both the vehicle and the keyless-entry device. In a seventh example of the method, optionally including one or more or each of the first through sixth examples, the vehicular keyless entry system is one of a remote keyless entry (RKE) system and a passive keyless entry (PKE) system. In an eighth example of the method, optionally including one or more or each of the first through seventh examples, the functionality of the vehicle is one of a door-lock functionality, a door-unlock functionality, a vehicle-start functionality, and a window-control functionality.

The disclosure also provides support for a method for a vehicular keyless entry system, comprising: detecting, at a keyless-entry device of a vehicle, a request for a selected functionality of a plurality of functionalities of the vehicle, identifying a function code of a plurality of predetermined function codes of the vehicle corresponding with the plurality of functionalities, the function code corresponding with the selected functionality, encrypting the function code of the vehicle into an identification (ID) code portion using a predetermined public key of the vehicle, and generating, at the keyless-entry device, a keyless-entry transmission carrying the ID code portion. In a first example of the method, the keyless-entry transmission carries a digital signature portion, comprising: generating the digital signature portion based on the ID code portion and a private key of the keyless-entry device. In a second example of the method, optionally including the first example, the private key of the keyless-entry device is stored in a Replay Protected Memory Block (RPMB) of the keyless-entry device. In a third example of the method, optionally including one or both of the first and second examples, the public key of the vehicle is stored in a write-protected memory of the keyless-entry device. In a fourth example of the method, optionally including one or more or each of the first through third examples comprising: transmitting the keyless-entry transmission via a radio frequency (RF) transceiver of the keyless-entry device. In a fifth example of the method, optionally including one or more or each of the first through fourth examples, the plurality of predetermined function codes corresponding with the plurality of functionalities of the vehicle are generated by a true random number generator (TRNG) for the vehicle and are assigned to both the keyless-entry device and the vehicle. In a sixth example of the method, optionally including one or more or each of the first through fifth examples, the vehicular keyless entry system is one of a remote keyless entry (RKE) system and a passive keyless entry (PKE) system. In a seventh example of the method, optionally including one or more or each of the first through sixth examples, the function code corresponds with one of a door-lock functionality, a door-unlock functionality, a vehicle-start functionality, and a window-control functionality.

The disclosure also provides support for a vehicular keyless entry system, comprising: a vehicle, and a keyless-entry device of the vehicle, wherein the keyless-entry device includes a first radio-frequency (RF) circuitry and one or more first processors having executable instructions stored in a first non-transitory memory that, when executed, cause the one or more first processors to: detect a request for a functionality of a plurality of functionalities of the vehicle, identify a function code corresponding with the requested functionality of the vehicle, the function code being one of a plurality of function codes respectively corresponding with the plurality of functionalities, encrypt the function code using a public key of the vehicle, and transmit, via the first RF circuitry, a keyless-entry transmission, wherein an ID code portion carried by the keyless-entry transmission contains the encrypted function code, and wherein the vehicle includes a second RF circuitry and one or more second processors having executable instructions stored in a second non-transitory memory that, when executed, cause the one or more second processors to: receive, via the second RF circuitry, the keyless-entry transmission, decrypt the ID code portion carried by the keyless-entry transmission using a private key of the vehicle, detect whether the decrypted ID code portion matches any of the plurality of function codes of the vehicle, and execute the functionality of the vehicle corresponding with the function code of the vehicle that matches the decrypted ID code portion. In a first example of the system, the keyless-entry transmission carries a digital signature portion, wherein the executable instructions stored in the first non-transitory memory, when executed, further cause the one or more first processors to generate the digital signature portion based on the encrypted function code and a private key of the keyless-entry device, and wherein the executable instructions stored in the second non-transitory memory, when executed, further cause the one or more second processors to verify the digital signature portion based on the decrypted ID code portion and a public key of the keyless-entry device. In a second example of the system, optionally including the first example, the vehicle includes a secondary power source coupled to the second RF circuitry, the second non-transitory memory, and the one or more second processors, the secondary power source providing power at least when power is not available from a primary power source of the vehicle.

In an alternative representation, the disclosure also provides support for a method wherein a function code associated with a functionality of the vehicle is signed in a first step, and then the signed function code is subsequently encrypted for transmission in the cryptographic message at the CID. When the cryptographic message is received at the vehicle, the encrypted, signed function code may be decrypted in a first step, and the signed function code may be verified in a second step.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the embodiments described above with respect to FIGS. 1-5. The methods may be performed by executing stored instructions with one or more logic devices (e.g., processors) in combination with one or more hardware elements, such as storage devices, memory, hardware network interfaces/antennas, switches, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

Terminology in which elements are presented in a list using “and/or” language means any combination of the listed elements. For example, “A, B, and/or C” may mean any of the following: A alone; B alone; C alone; A and B; A and C; B and C; or A, B, and C.

1. A method for a vehicular keyless entry system, comprising:
processing, at a vehicle, a keyless-entry transmission carrying an identification (ID) code portion;
decrypting the ID code portion of the keyless-entry transmission using a private key of the vehicle;
detecting whether the decrypted ID code portion matches one of a plurality of predetermined function codes of the vehicle; and
executing a functionality of the vehicle corresponding with a function code of the vehicle that matches the decrypted ID code portion.

2. The method of claim 1, wherein the private key of the vehicle is stored in a Replay Protected Memory Block (RPMB) of the vehicle.

3. The method of claim 1, wherein the decrypting of the ID code portion is done at an electronic control unit (ECU) of the vehicle powered by a secondary power source of the vehicle.

4. The method of claim 3, comprising:
receiving the keyless-entry transmission via a radio frequency (RF) transceiver coupled to the ECU.

5. The method of claim 1, wherein the keyless-entry transmission carries a digital signature portion, comprising:
verifying the digital signature portion of the keyless-entry transmission based on the ID code portion and a predetermined public key of a keyless-entry device of the vehicle.

6. The method of claim 5, wherein the public key of the keyless-entry device is stored in a write-protected memory of the vehicle.

7. The method of claim 5, wherein the plurality of predetermined function codes corresponding with a plurality of functionalities of the vehicle are generated by a true random number generator (TRNG) for the vehicle and are assigned to both the vehicle and the keyless-entry device.

8. The method of claim 1, wherein the vehicular keyless entry system is one of a remote keyless entry (RKE) system and a passive keyless entry (PKE) system.

9. The method of claim 1, wherein the functionality of the vehicle is one of a door-lock functionality, a door-unlock functionality, a vehicle-start functionality, and a window-control functionality.

10. A method for a vehicular keyless entry system, comprising:
detecting, at a keyless-entry device of a vehicle, a request for a selected functionality of a plurality of functionalities of the vehicle;
identifying a function code of a plurality of predetermined function codes of the vehicle corresponding with the plurality of functionalities, the function code corresponding with the selected functionality;
encrypting the function code of the vehicle into an identification (ID) code portion using a predetermined public key of the vehicle; and
generating, at the keyless-entry device, a keyless-entry transmission carrying the ID code portion.

11. The method of claim 10, wherein the keyless-entry transmission carries a digital signature portion, comprising:
generating the digital signature portion based on the ID code portion and a private key of the keyless-entry device.

12. The method of claim 11, wherein the private key of the keyless-entry device is stored in a Replay Protected Memory Block (RPMB) of the keyless-entry device.

13. The method of claim 10, wherein the public key of the vehicle is stored in a write-protected memory of the keyless-entry device.

14. The method of claim 10, comprising:
transmitting the keyless-entry transmission via a radio frequency (RF) transceiver of the keyless-entry device.

15. The method of claim 10, wherein the plurality of predetermined function codes corresponding with the plurality of functionalities of the vehicle are generated by a true random number generator (TRNG) for the vehicle and are assigned to both the keyless-entry device and the vehicle.

16. The method of claim 10, wherein the vehicular keyless entry system is one of a remote keyless entry (RKE) system and a passive keyless entry (PKE) system.

17. The method of claim 10, wherein the function code corresponds with one of a door-lock functionality, a door-unlock functionality, a vehicle-start functionality, and a window-control functionality.

18. A vehicular keyless entry system, comprising:
a vehicle; and
a keyless-entry device of the vehicle,
wherein the keyless-entry device includes a first radio-frequency (RF) circuitry and one or more first processors having executable instructions stored in a first non-transitory memory that, when executed, cause the one or more first processors to:
detect a request for a functionality of a plurality of functionalities of the vehicle;
identify a function code corresponding with the requested functionality of the vehicle, the function code being one of a plurality of function codes respectively corresponding with the plurality of functionalities;
encrypt the function code using a public key of the vehicle; and
transmit, via the first RF circuitry, a keyless-entry transmission, wherein an ID code portion carried by the keyless-entry transmission contains the encrypted function code, and
wherein the vehicle includes a second RF circuitry and one or more second processors having executable instructions stored in a second non-transitory memory that, when executed, cause the one or more second processors to:
receive, via the second RF circuitry, the keyless-entry transmission;
decrypt the ID code portion carried by the keyless-entry transmission using a private key of the vehicle;
detect whether the decrypted ID code portion matches any of the plurality of function codes of the vehicle; and
execute the functionality of the vehicle corresponding with the function code of the vehicle that matches the decrypted ID code portion.

19. The vehicular keyless entry system of claim 18,
wherein the keyless-entry transmission carries a digital signature portion;
wherein the executable instructions stored in the first non-transitory memory, when executed, further cause the one or more first processors to generate the digital signature portion based on the encrypted function code and a private key of the keyless-entry device; and
wherein the executable instructions stored in the second non-transitory memory, when executed, further cause the one or more second processors to verify the digital signature portion based on the decrypted ID code portion and a public key of the keyless-entry device.

20. The vehicular keyless entry system of claim 18, wherein the vehicle includes a secondary power source coupled to the second RF circuitry, the second non-transitory memory, and the one or more second processors, the secondary power source providing power at least when power is not available from a primary power source of the vehicle.
